(19) United States
(12) Patent Application Publication
(10) Pub. No.: US 2016/0010835 A1
(43) Pub. Date: Jan. 14, 2016

(54) LIGHTING INSTALLATION ASSEMBLY

(71) Applicant: DONGBU LIGHTEC CO., LTD., Bucheon-si (KR)

(72) Inventors: Young Ju LEE, Bucheon-si (KR); Yun Jai CHOO, Incheon (KR); Seong Eun OH, Suwon-si (KR)

(21) Appl. No.: 14/474,409

(22) Filed: Sep. 2, 2014

(30) Foreign Application Priority Data
Jul. 8, 2014 (KR) 10-2014-0085250

(51) Int. Cl. F21V 21/14; F21V 21/02

(52) U.S. Cl. CPC F21V 21/14; F21V 21/02; F21Y 2101/02

(57) ABSTRACT

A lighting installation assembly includes a first bracket directly or indirectly fixed to a ceiling or a wall surface, and a second bracket fastened to the first bracket in a state in which a lighting is fixed to the second bracket. One of the first bracket and the second bracket is formed with an interlocking wing part and the other is formed with an interlocking blade part configured to be caught on the interlocking wing part. When the second bracket is rotated in a forward direction in a state in which the interlocking wing part is caught on the interlocking blade part, the second bracket is fastened to the first bracket such that the rotation of the second bracket in the forward or backward direction is suppressed. One worker may easily install the lighting installation assembly on a ceiling or a wall surface and rigidly assembly the lighting installation assembly.

### BACKGROUND OF THE INVENTION

1. Field of the invention

The present invention relates to a lighting installation assembly, and more particularly, to a lighting installation assembly which is configured such that a worker can install a lighting quickly and easily on a ceiling or a wall surface by himself/herself.

2. Description of the Prior Art

A lighting device may be a fixed type or a portable type, which is designed and used to emit lamp light. The lighting device is variously classified as a desk lamp, a table lamp, a pillar lamp, a ceiling lamp, or the like according to a use or an installation place thereof.

Among them, the ceiling lamp and the wall lamp are lighting devices which are installed on a ceiling and a wall of a building, respectively, and connected with an electric wire, which is wired inside or outside the ceiling or the wall. The ceiling light and the wall light are most widely used among the interior lighting devices of a building, such as an ordinary house, an airport lounge, a cafeteria, a school, a hospital, a library, a public restaurant, a public restroom, an indoor parking lot, or the like.

In connection with this, Korean Registered Utility Model Publication No. 463465 discloses an LED lighting. The LED lighting disclosed in Korean Registered Utility Model Publication No. 463465 includes: a case formed of an aluminum material in a rectangular shape, and provided with a plurality of heat sinks which are formed on a rear surface thereof to vertically and integrally protrude in one direction, and guide steps which are formed at opposite ends of a front surface thereof to protrude in one direction; a metallic Printed Circuit Board (PCB) formed of an aluminum material, and fitted on and bolted to the guide steps of the case in a state in which a plurality of LEDs and circuit elements are mounted on a front surface of the metallic PCB; a lens formed in a conical shape which is opened on top and bottom surfaces thereof, the LEDs mounted on the front surface of the metallic PCB being inserted into the bottom surface of the lens and a diffusion plate being provided on the top surface of the lens; a reflective anchoring plate formed of a stainless steel material in a rectangular plate shape and having a first opening hole formed at a position corresponding to the lens, the reflective fixing plate being bolted in a state in which opposite ends of the reflective anchoring plate are fitted on the guide steps on the case so as to fix the lens; an auxiliary LED module fixed by a bent bracket which is bent vertically at opposite ends of the top surface of the case; a glass cover, to which sealing materials formed of silicon are attached to opposite ends of the bottom surface of the glass cover in one direction, the opposite ends being fitted on the guide steps of the case to be cradled on the top surface of the case in a state; side covers bolted to opposite side surfaces of the case, each of the side covers being formed with a second opening hole at a position corresponding to the auxiliary LED module to expose the auxiliary LED and being bent to support the glass cover; a fixing bracket formed of a metallic material in a “ [symbol] ” shape, opposite ends of the fixing bracket being coupled to the opposite side surfaces of the case; and a convertor module fixedly installed on the rear surface of the case between the heat sinks and supplying power to the LED of the metallic PCB and the auxiliary LED module.

However, the conventional lighting disclosed in Korean Registered Utility Model Publication No. 463465 is configured such that the fixing bracket is fixed to an angle installed on the ceiling by bolts and then electrically connected with a wiring provided on the ceiling or the wall. In order to connect the angle and the fixing bracket with the bolts, one worker should raise the lighting such that the bolt holes of the angle and the fixing bracket coincide with each other and another worker should perform the bolting operation. As a result, installation of the lighting requires two workers and takes a long time due to the complicated installation procedure as described above. In particular, when the lighting is large, it is impossible for one worker to install the lighting.

Further, since the conventional lighting disclosed in Korean Registered Utility Model Publication No. 463465 is configured such that the fixing bracket is fixed to the angle installed on the ceiling with bolts and then electrically connected with the wiring provided on the ceiling or the wall, a wire is exposed to the outside.

Moreover, since an additional structure is required to shield the wiring in order not to expose the wiring, material costs of the lighting increase and an operation time further increases.

### PRIOR ART DOCUMENT

### Patent Document

Korean Registered Utility Model Publication No. 463465 (registered on Oct. 30, 2012)

### SUMMARY OF THE INVENTION

An object of the present invention is to provide a lighting installation assembly which is configured such that one worker may easily install the lighting installation assembly on a ceiling or a wall surface and rigidly assembly the lighting installation assembly by himself/herself, and an installation time may be reduced.

Further, another object is to provide a lighting installation assembly which is configured such that the one worker can simultaneously perform a wiring operation and a fixing operation and when the fixing operation is completed by himself/herself, no wiring is exposed to the outside.

In order to achieve the above-described objects, according to the present invention, there is provided a lighting installation assembly including a first bracket directly or indirectly fixed to a ceiling or a wall surface, and a second bracket fastened to the first bracket in a state in which a lighting is fixed to the second bracket. One of the first bracket and the second bracket is formed with an interlocking wing part and the other is formed with an interlocking blade part configured to be caught on the interlocking wing part. When the second bracket is rotated in a forward direction in a state in which the interlocking wing part is caught on the interlocking blade part, the second bracket is fastened to the first bracket such that the rotation of the second bracket in the forward or backward direction is suppressed.

The first bracket may be formed with a fastening recess, and the second bracket may be formed with a fastening protrusion such that when the fastening protrusion is inserted into the fastening recess, the rotation in the forward or backward direction may be suppressed.

The first bracket may include a first coupling plate part configured to be directly or indirectly fixed to the ceiling or the wall surface, and a first bent part which is bent downward at an end of the first coupling plate part. The fastening recess is formed on the first bent part. The second bracket may include a second coupling plate part where the lighting is fixed and a second bent part which is bent downward at an end of the second coupling plate part. The fastening protrusion is formed on the second bent part.

The interlocking wing part may be formed at an end of the first coupling plate part at an opposite side to the first bent part, and the interlocking blade part may be formed at an end of the second coupling plate part at an opposite side to the second bent part.

The first bent part and the second bent part approach each other or come in close contact with each other in a state in which the fastening protrusion is inserted into the fastening recess. In addition, the first bent part and the second bent part may be formed with coupling holes to positionally correspond to each other.

The first bracket is formed with a wire passage opening through which a wire from the ceiling or the wall surface passes, and the second bracket is formed with a lead passage opening through which a lead from the lighting passes. When the first bracket and the second bracket are fastened to each other, the wire passage opening and the lead passage opening may face each other.

An extension may be formed on the lighting configured to allow the lead to pass therethrough, and when the first bracket and the second bracket are fastened to each other, the extension may be inserted into the wire passage opening.

According to the present invention, there is provided a lighting installation assembly including a first bracket directly or indirectly fixed to a ceiling or a wall surface, and a second bracket fastened to the first bracket in a state in which a lighting is fixed to the second bracket. One of the first bracket and the second bracket is formed with an interlocking wing part and the other is formed with an interlocking blade part configured to be caught on the interlocking wing part. When the second bracket is rotated in a forward direction in a state in which the interlocking wing part is caught on the interlocking blade part, the second bracket is fastened to the first bracket such that the rotation of the second bracket in the forward or backward direction is suppressed. As a result, it is possible to provide a lighting installation assembly which is configured such that one worker may easily install the lighting installation assembly on a ceiling or a wall surface and rigidly assembly the lighting installation assembly by himself/herself, and an installation time may be reduced.

In addition, the first bracket is formed with a wire passage opening through which a wire from the ceiling or the wall surface passes, and the second bracket is formed with a lead passage opening through which a lead from the lighting passes. When the first bracket and the second bracket are fastened to each other, the wire passage opening and the lead passage opening may face each other. As a result, it is possible to provide a lighting installation assembly which is configured such that the one worker can simultaneously perform a wiring operation and a fixing operation by himself/herself and when the fixing operation is completed, no wiring is exposed to the outside.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are perspective views illustrating a lighting installation assembly according to an exemplary embodiment of the present invention;

FIG. 3 is an exploded perspective view of the lighting installation assembly of FIG. 1; and

FIGS. 4a to 4d are views illustrating the lighting installation assembly in a use state.

### DETAILED DESCRIPTION OF THE EXEMPLARY EMBODIMENTS

Hereinafter, exemplary embodiments of the present invention will be described in detail with reference to accompanying drawings. In the description of the present invention, the description of the well-known function or structure will be omitted in order to clear the subject matter of the present invention.

A lighting installation assembly according to the present invention is configured such that one worker may easily install the lighting installation assembly on a ceiling or a wall surface and rigidly assembly the lighting installation assembly by himself/herself, and an installation time may be reduced.

In addition, a lighting installation assembly is configured such that the one worker can simultaneously perform a wiring operation and a fixing operation by himself/herself and when the fixing operation is completed, no wiring is exposed to the outside.

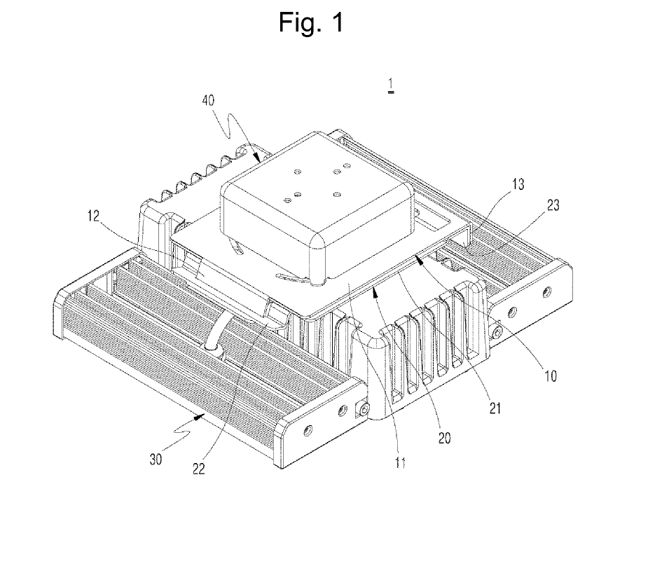

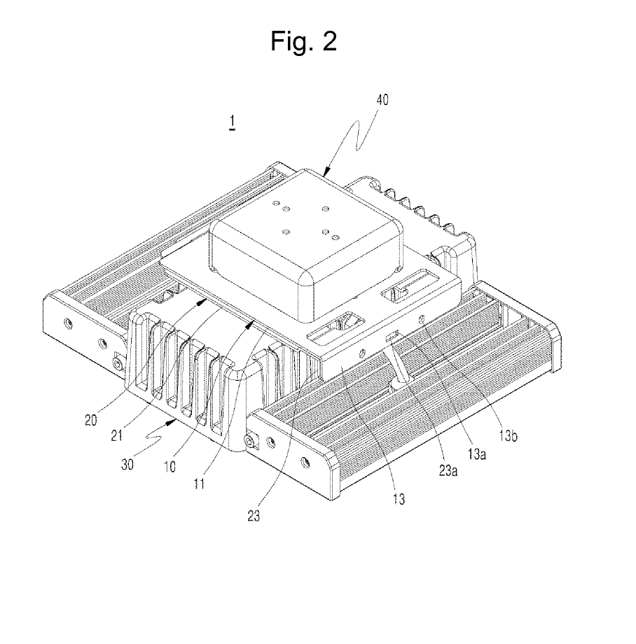

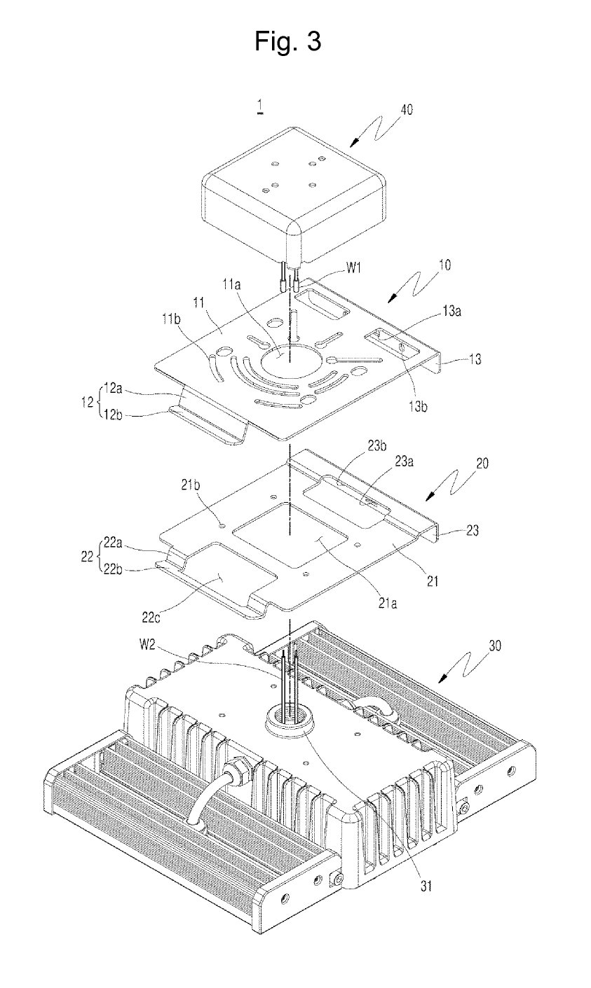

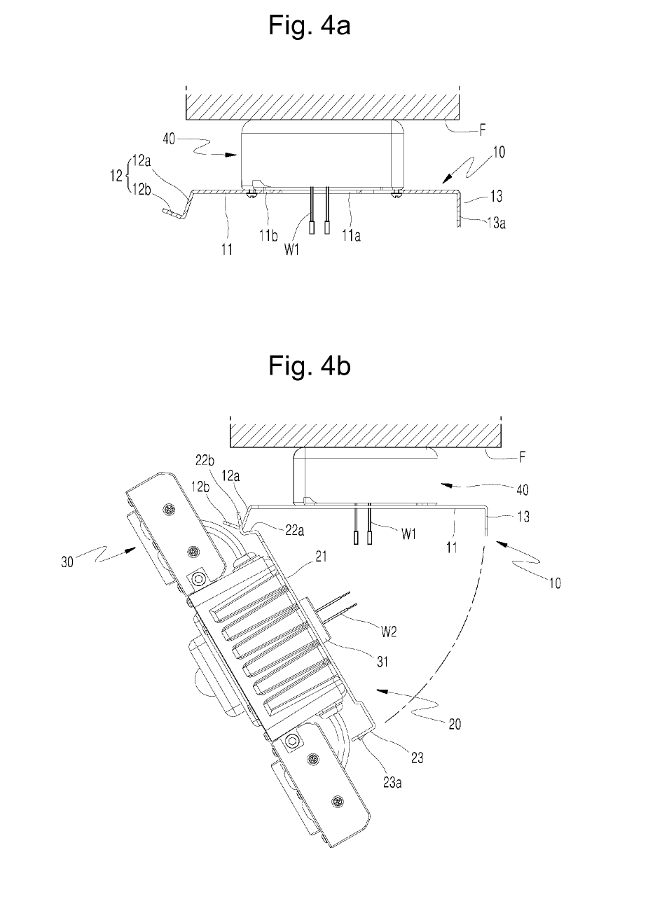

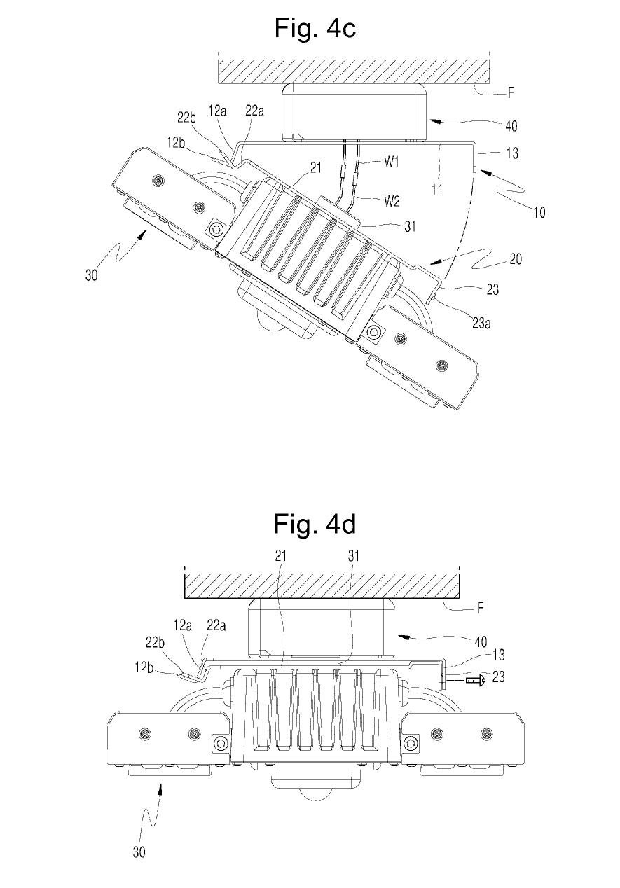

FIGS. 1 and 2 are perspective views illustrating a lighting installation assembly according to an exemplary embodiment of the present invention, FIG. 3 is an exploded perspective view of the lighting installation assembly of FIG. 1, and FIGS. 4a to 4d are views illustrating the lighting installation assembly in a use state.

As illustrated in FIGS. 1 to 3, a lighting installation assembly 1 according to an embodiment of the present invention is configured such that one worker can quickly and easily install a lighting 30 on a ceiling or a wall by himself/herself. The lighting installation assembly 1 includes a first bracket 10, a second bracket 20, and a lighting 30.

The lighting installation assembly 1 of the present invention may be used when the lighting 30 is installed on a wall. However, in an exemplary embodiment of the present invention, descriptions will be made assuming that the lighting installation assembly 1 is installed on a ceiling surface F (see FIG. 4d). In general, the ceiling surface F refers to an uppermost surface in a defined indoor space. However, in the present invention, the ceiling surface F refers to a surface on which a lighting may be installed above a person's head, such as a bottom surface of a duct or a beam.

Referring to FIG. 4a, the first bracket 10 is directly or indirectly fixed to the ceiling surface F and the second bracket 20 is detachably coupled thereto. Thus, although the first bracket 10 may be directly fixed to the ceiling surface F, an exemplary embodiment of the present invention will be described assuming that the first bracket 10 is fixed to a junction box 40 installed on the ceiling surface F.

As known in the related art, the junction box 40 is a cover used so as to protect wires which are interconnected with each other, and may be used as a means for protecting a wire W1 branched at each lighting 30 and fixing the lighting 30 in a place where a plurality of lightings 30 are installed on a ceiling surface F, such as an underground parking lot of a large building.

As illustrated in FIGS. 1 to 3, the junction box 40 is formed in a box shape in which through-holes are formed on a top surface of the junction box 40 so as to fasten the junction box 40 to the ceiling surface F using bolts. An opening (not illustrated) is formed in a bottom of the junction box 40 so as to draw out the wire W1 downward.

The first bracket 10 includes a first coupling plate part 11, an interlocking wing part 12, and a first bent part 13.

The first coupling plate part 11 is configured to be fastened to a lower end of the junction box 40, and is formed in a substantially flat plate shape to extend horizontally in a state in which the first coupling plate part 11 is fastened to the lower end of the junction box 40. Through-holes 11b are formed in the first coupling plate part 11 so as to couple the first coupling plate part 11 to the bottom of the junction box 40 using bolts.

A plurality of through-holes 11b are formed in a circumferential direction and a radial direction with reference to the center of the junction box 40 in order to assure that the first coupling plate part 11 can be fastened to junction boxes 40 of various sizes. Fastening holes (not illustrated) coupled to the through-holes 11b by the bolts are formed in the lower end of the junction box 40.

At the center of the first coupling plate part 11, a wire passage opening 11a is formed so as to allow the wire W1 of the junction box 40 to pass therethrough. As illustrated in FIG. 4c, the wire W1 of the junction box 40 is drawn out downward through the wire passage opening 11a and connected to a lead W2 of the lighting 30. This will be described in detail below.

As illustrated in FIGS. 1 to 3, the interlocking wing part 12 is configured to protrude by being bent at the end of first coupling plate part 11 such that the interlocking blade part 22 of the second bracket 20 is caught on the interlocking wing part 12. The interlocking wing part 12 includes a first interlocking wing portion 12a slantly protruding downward from the end of the first coupling plate part 11, and a second interlocking wing portion 12b slantly protruding upward from the end of the first interlocking wing portion 12a.

The first bent part 13 is bent downward at the opposite side of the interlocking wing part 12 and is formed with a fastening recess 13a into which a fastening protrusion 23a of the second bracket 20 is inserted. In addition, the first bent part 13 is formed with a coupling hole 13b so that the first bent part 13 may be fastened to the second bent part 23 by a bolt inserted through the coupling hole 13b.

As illustrated in FIGS. 1 to 3, the second bracket 20 is configured to be detachably coupled to the first bracket 10 in a state in which the lighting 30 is fixed to the second bracket 20 in which the second bracket 20 includes a second coupling plate part 21, an interlocking blade part 22, and a second bent part 23.

The lighting 30 is fixed to the bottom surface of the second coupling plate part 21 which is formed in a substantially flat plate shape in a horizontal direction. The second coupling plate part 21 is formed with through-holes 21b such that the second coupling plate part 21 is coupled with the lighting 30 by bolts.

The interlocking blade part 22 is configured such that the second bracket 20 is caught on the interlocking wing part 12 of the first bracket 10 in the direction of gravity. The interlocking blade part 22 includes a first interlocking blade portion 22a slantly protruding downward from an end of the second coupling plate part 21 and a second interlocking blade portion 22b slantly protruding upward from an end of the first interlocking blade portion 22a.

A catch opening 22c is formed in the second interlocking blade portion 22b such that the interlocking wing part 12 is inserted into the catch opening 22c. In order to allow the worker to easily insert the interlocking wing part 12 into the catch opening 22c, the catch opening 22c may be formed to be elongated over the first interlocking blade portion 22a and the second interlocking blade portion 22b, or over the first interlocking blade portion 22a and the second coupling plate part 21.

Referring to FIG. 4b, the second bracket 20 is caught on the interlocking wing part 12 through the catch opening 22c so that second interlocking blade portion 22b is positioned above the second interlocking wing portion 12b.

When the interlocking blade part 22 is caught on the interlocking wing part 12 through the catch opening 22c, the second bracket 20 is maintained in a state in which the second bracket 20 hangs from the first bracket 10 even if the worker does not support the second bracket 20.

That is, since the interlocking wing part 12 includes the first interlocking wing portion 12a slantly protruding downward from the end of the first coupling plate part 11 and second interlocking wing portion 12b slantly protruding upward from the end of the first interlocking wing portion 12a, the interlocking blade part 22 is caught a recessed portion between the first interlocking wing portion 12a and the second interlocking wing portion 12b through the catch opening 22c, thereby stably maintaining the hanging state.

The second bent part 23 is bent downward at the opposite side to the interlocking blade part 22, and a fastening protrusion 23a is formed on the second bent part 23 to be inserted into a fastening recess 13a of the first bracket 10. A coupling hole 23b is formed in the second bent part 23 to correspond to the coupling hole 13b of the first bent part 13.

A lead passage opening 21a is formed at the center of the second coupling plate part 21 in which the lead W2 of the lighting 30 passes through the lead passage opening 21a. When the first bracket 10 and the second bracket 20 are coupled to each other, the wire passage opening 11a and the lead passage opening 21a face each other.

Referring to FIGS. 4a to 4d, the installation process of the lighting installation assembly 1 of the present invention may be conducted by one worker alone.

As illustrated in FIG. 4a, the first bracket 10 is coupled to the lower end of the junction box 40 installed on the ceiling surface F. The junction box 40 is fixed to the ceiling surface F by bolts inserted through the through-holes 11b. Specifically, the worker inserts the bolts through the through-holes 11b of the first bracket 10 and fastens the bolts to the fastening holes of the junction box 40 so as to fix the first bracket 10 to the junction box 40. The wire W1 of the junction box 40 is drawn out downward through the wire passage opening 11a of the second bracket 20.

As illustrated in FIG. 4b, the second bracket 20 is caught on the interlocking wing part 12 of the first bracket 10 through the catch opening 22c of the interlocking blade part 22 in a state in which the lighting 30 is coupled to the second bracket 20. The lead W2 of the lighting 30 is drawn out upward through the lead passage opening 21a of the second bracket 20 for wiring connection with the wire W1 of the junction box 40.

The second bracket 20 is maintained in the state in which the second bracket 20 is hanging from the first bracket 10 even if the worker does not support the second bracket 20 in the state where the interlocking blade part 22 is inserted into the interlocking wing part 12. A hanging angle of the second bracket 20 is formed depending on the weights of the second bracket 20 and the lighting 30. Since the lighting 30 is coupled to the bottom surface of the second bracket 20 and the center of weight is positioned at the lighting 30 side, the second bracket 20 hangs while forming an acute angle in relation to the first bracket 10.

The second bracket 20 rotatably hangs from the first bracket 10. That is, when the interlocking blade part 22 is caught on the interlocking wing part 12 through the catch opening 22c, the second interlocking blade portion 22b is positioned between the first interlocking wing portion 12a and the second interlocking wing portion 12b such that the second interlocking blade portion 22b may be rotated within the included angle between the first interlocking wing portion 12a and the second interlocking wing portion 12b.

The included angle between the first interlocking wing portion 12a and the second interlocking wing portion 12b refers to an angle within which the second bracket may be rotated in a state in which the first bracket 10 and the second bracket 20 are completely coupled to each other so that the first coupling plate part 11 and the second coupling plate part 21 face each other.

The included angle between first interlocking wing portion 12a and the second interlocking wing portion 12b is preferably formed not to exceed 90 degrees such that the first coupling plate part 11 and the second coupling plate part 21 do not form an obtuse angle therebetween, even if the fastening protrusion 23a is released from the fastening recess 13a and the second bracket 20 is rotated due to its own weight.

When the included angle between the first coupling plate part 11 and the second coupling plate part 21 form an acute angle, excessive rotation of the second bracket 20 is suppressed, even if the fastening protrusion 23a is released from the fastening recess 13a and thus the second bracket 20 is rotated by its own weight. As a result, it is possible to prevent tension from being applied to the wire W1 and the lead W2.

In the state in which the interlocking blade part 22 is caught on the interlocking wing part 12 through the catch opening 22c, the included angle between the first coupling plate part 11 and the second coupling plate part 21 is less than 90 degrees due to the weight of the lighting 30 fixed to the bottom surface of the second coupling plate part 21, and the wire W1 drawn out through the wire passage opening 11a and the lead W2 drawn out through the lead passage opening 21a slantly face each other.

Since the second bracket 20 is maintained in the state it hangs from the first bracket 10 even if it is not supported by the worker, the worker may perform a connection operation of the wire W1 and the lead W2 by himself/herself.

As illustrated in FIGS. 4c and 4d, when the connection operation of the wire W1 and the lead W2 is completed, the worker rotates the second bracket 20 such that the second coupling plate part 21 and the first coupling plate part 11 approach each other. The fastening protrusion 23a is inserted into the fastening recess 13a when the bottom surface of the first coupling plate part 11 and the top surface of the second coupling plate part 21 face each other.

As the second bracket 20 is rotated, the second bent part 23 is rotated toward the first coupling plate part 11 in a state in which the second bent part 23 is in close contact with the first bent part 13 or is slightly spaced from the first bent part 13. The first coupling plate part 11 and the first bent part 13 forms an included angle which is the same as that between the second coupling plate part 21 and the second bent part 23.

The fastening protrusion 23a is bent to be inclined as distance from the first bent part 13 increases such that the inclined surface is elastically deformed by the first bent part 13 and then inserted into the fastening recess 13a. When the fastening protrusion 23a is inserted into the fastening recess 13a, the top surface of the second coupling plate part 21 and the bottom surface of the first coupling plate part 11 approach each other or come in contact with each other so that bi-directional rotation of the second coupling plate part 21 is suppressed.

The top surface of the second coupling plate part 21 and the bottom surface of the first coupling plate part 11 may entirely approach each other or come in close contact with each other. However, even if they only partially approach each other or come in contact with each other as illustrated in FIG. 4d, the rotation of the second bracket 20 may be restrained. Thus, it is preferable that the first coupling plate part 11 and the second coupling plate part 21 approach each other or come in close contact with each other at the portions adjacent to the first bent part 13 and the second bent part 23. Then, the first bent part 13 and the second bent part 23 are fastened to each other by a bolt inserted through the coupling hole 13b.

In the state in which the fastening protrusion 23a is inserted into the fastening recess 13a, the bottom surface of the second interlocking blade portion 22b comes in close contact with the second interlocking wing portion 12b. In addition, in the state in which the bottom surface of the second interlocking blade portion 22b is in close contact with the top surface of the second interlocking wing portion 12b, the second interlocking blade portion 22b comes in close contact with the first interlocking blade portion 22a through the catch opening 22c. Therefore, the movement of the second bracket 20 in a horizontal direction from the first bracket 10 is suppressed.

In addition, when the bottom surface of the second interlocking blade portion 22b and the top surface of the second interlocking wing portion 12b come in close contact with each other, the second bracket 20 is prevented from being further rotated toward the first bracket 10 after the fastening protrusion 23a is inserted into the fastening recess 13a.

As illustrated in FIGS. 4b to 4d, the wire W1 and the lead W2 which are interconnected with each other are put into the inside of the junction box 40 while the second bracket 20 is rotated such that the fastening protrusion 23a is inserted into the fastening recess 13a. Accordingly, the lighting installation assembly 1 of the present invention does not require a structure for shielding external exposure of the wire W1 and the lead W2, and it is not necessary for the user to arrange the interconnected wire W1 and lead W2.

An extension 31 is formed on the top of the lighting 30, in which the lead W2 is drawn out through the extension 31 and when the first bracket 10 and the second bracket 20 are fastened to each other, the extension 31 is inserted into the wire passage opening 11a. When the extension 31 is formed, as illustrated in FIG. 4d, exposure of the wire W1 and the lead W2 may be completely shielded in the state in which the first bracket 10 and the second bracket 20 are coupled to each other.

According to the present invention, it is possible to provide a lighting installation assembly 1 including: a first bracket 10 directly or indirectly fixed to a ceiling or a wall surface; and a second bracket 20 configured to be fastened to the first bracket 10 in a state in which a lighting 30 is fixed to the second bracket 20, in which one of the first bracket 10 and the second bracket 20 is formed with an interlocking wing part 12 and the other is formed with an interlocking blade part 22 configured to be caught on the interlocking wing part 12. When the second bracket 20 is rotated in a forward direction in a state in which the interlocking wing part 12 is caught on the interlocking blade part 22, the second bracket 20 is fastened to the first bracket 10 such that the rotation of the second bracket 20 in the forward or backward direction is suppressed. As a result, the worker can easily install the lighting installation assembly 1 on the ceiling or the wall surface and rigidly assembled by himself/herself, and the installation can be performed within a reduced length of time.

Further, it is possible to provide a lighting installation assembly 1 in which the first bracket 10 is formed with a wire passage opening 11a through which a wire W1 from the ceiling or the wall surface passes, and the second bracket is formed with a lead passage opening 21a through which a lead W2 from the lighting 30 passes. The wire passage opening 11a and the lead passage opening 21a are formed to face each other when the first bracket 10 and the second bracket 20 are fastened to each other. Accordingly, the worker can simultaneously perform the wiring operation and the fixing operation of the wire W1 by himself/herself, and when the fixing operation is completed, the wire W1 is not exposed to the outside.

Although the exemplary embodiment of the present invention is described and shown, it is obvious to a person skilled in the art that the present invention is not limited to the described embodiment and may be changed and modified in various forms without departing from the spirit and scope of the present invention. Accordingly, modifications or variations should not be individually understood in view of the technical spirit of the present invention, and it must be understood the modifications and the variations belong to the claims of the present invention.

What is claimed is:

1. A lighting installation assembly comprising:
a first bracket directly or indirectly fixed to a ceiling or a wall surface; and
a second bracket fastened to the first bracket in a state in which a lighting is fixed to the second bracket,
wherein one of the first bracket and the second bracket is formed with an interlocking wing part and the other is formed with an interlocking blade part configured to be caught on the interlocking wing part, and
when the second bracket is rotated in a forward direction in a state in which the interlocking wing part is caught on the interlocking blade part, the second bracket is fastened to the first bracket such that the rotation of the second bracket in the forward or backward direction is suppressed.

2. The lighting installation assembly of claim 1, wherein the first bracket is formed with a fastening recess, and the second bracket is formed with a fastening protrusion such that when the fastening protrusion is inserted into the fastening recess, the rotation in the forward or backward direction is suppressed.

3. The lighting installation assembly of claim 2, wherein the first bracket includes a first coupling plate part configured to be directly or indirectly fixed to the ceiling or the wall surface, and a first bent part which is bent downward at an end of the first coupling plate part, the fastening recess being formed on the first bent part, and
the second bracket includes a second coupling plate part where the lighting is fixed and a second bent part which is bent downward at an end of the second coupling plate part, the fastening protrusion being formed on the second bent part.

4. The lighting installation assembly of claim 3, wherein the interlocking wing part is formed at an end of the first coupling plate part at an opposite side to the first bent part, and the interlocking blade part is formed at an end of the second coupling plate part at an opposite side to the second bent part.

5. The lighting installation assembly of claim 3, wherein the first bent part and the second bent part approach each other or come in close contact with each other in a state in which the fastening protrusion is inserted into the fastening recess, and
the first bent part and the second bent part are formed with coupling holes to positionally correspond to each other.

6. The lighting installation assembly of claim 1, wherein the first bracket is formed with a wire passage opening through which a wire from the ceiling or the wall surface passes,
the second bracket is formed with a lead passage opening through which a lead from the lighting passes, and
when the first bracket and the second bracket are fastened to each other, the wire passage opening and the lead passage opening face each other.

7. The lighting installation assembly of claim 6, wherein an extension is formed on the lighting configured to allow the lead to pass therethrough, and when the first bracket and the second bracket are fastened to each other, the extension is inserted into the wire passage opening.
